(19) United States
(12) Patent Application Publication
(10) Pub. No.: US 2019/0330783 A1
(43) Pub. Date: Oct. 31, 2019

(54) Wall-Mounted Washing Machine and Installation Method

(71) Applicant: Daewoo Electronics Corporation, Gwangju (KR)

(72) Inventor: Sang Ill BAE, Incheon (KR)

(21) Appl. No.: 16/388,717

(22) Filed: Apr. 18, 2019

(30) Foreign Application Priority Data
Apr. 27, 2018 (KR) 10-2018-0049465

(51) Int. Cl. D06F 39/00; G01B 11/14

(52) U.S. Cl. CPC D06F 39/001; G01B 11/14

(57) ABSTRACT

A wall-mounted washing machine and a method of installing a washing machine on a wall are disclosed. The wall-mounted washing machine may include a cabinet having an external shape; a rear panel configured to be mounted on a wall; a tub supported by the rear panel and configured to contain wash water; a front panel having an opening over the tub; a rotatable drum in the tub; and a distance sensor. The distance sensor may be at an upper portion or section or a lower portion or section of the washing machine.

### TECHNICAL FIELD

The present invention relates to a wall-mounted washing machine and an installation method thereof.

### BACKGROUND

A washing machine is an apparatus for separating contaminants from laundry (e.g., clothing) using wash water and detergent, and the contaminants can be separated from the laundry by chemical action of the detergent in the wash water and mechanical action of the wash water and an inner basket. Washing machines may be classified into a top loading type, a front loading type, and a hybrid type combining the top loading type and the front loading type, according to the method of putting laundry therein.

Recently, wall-mounted washing machines that can be installed in a narrow space such as a bathroom or the like are on the market, and general wall-mounted washing machines generally adopt the front loading method.

When a wall-mounted washing machine is installed or fixed on a wall, it should be installed in a manner to prevent falling during use. However, the wall-mounted washing machine may be separated from the wall and may fall when the installation process is incomplete, or vibrations generated while using the wall-mounted washing machine damage the parts that secure the washing machine to the wall. In this case, the wall-mounted washing machine may be broken or the user can be injured.

### SUMMARY

An object of the present invention is to provide a wall-mounted washing machine capable of sensing an abnormal installation state, and a method of installing such a washing machine on a wall.

In addition, another object of the present invention is to provide a wall-mounted washing machine capable of sensing the possibility of detaching from the wall and falling in advance, and a method of installing such a washing machine on a wall.

In accordance with an aspect of the present invention, there is provided a wall-mounted washing machine comprising a cabinet having an external shape; a rear panel configured to be mounted on a wall; a tub supported by the rear panel and configured to contain wash water; a front panel having an opening over the tub; a rotatable drum in the tub, and one or more distance sensors at a predetermined position (e.g., in the cabinet). For example, the distance sensor(s) may be below the tub.

The washing machine may further include a groove, slot, recess, depression or other opening (an “accommodation groove”) in a surface (e.g., of the cabinet) and having a preset height, length or depth. The distance sensor may be in the accommodation groove.

The washing machine may further include a window having a transmittance to radiation from the distance sensor (e.g., an optical transmittance, such as in an optically transparent plate) in the accommodation groove.

The washing machine may include two or more distance sensors, spaced apart from each other by a preset distance (e.g., in or along a width direction of the washing machine).

The washing machine may further comprise a control unit configured to sense an abnormal installation state (e.g., by determining when a difference between distances sensed by the two distance sensors exceeds [e.g., is outside of] a preset range or exceeds [e.g., is greater than] a preset threshold).

The washing machine may further comprise a control unit configured to sense when a difference between a current difference value between distances from the two distance sensors and an initial difference (e.g., corresponding to a difference of distances sensed by the two distance sensors when the two distance sensors initially operate) exceeds a preset range or threshold.

The washing machine may further comprise a control unit configured to compare an initial distance from the distance sensor(s) (e.g., when the distance sensor[s] initially operate) and a current distance from the distance sensor(s), and determine whether the current distance differs from the initial distance, or when a difference between the current distance and the initial distance exceeds or is smaller than a preset value or threshold.

In accordance with another aspect of the present invention, there is provided a wall-mounted washing machine comprising a cabinet having an external shape; a rear panel configured to be mounted on a wall; a tub supported by the rear panel and configured to contain wash water; a front panel having an opening over the tub; and a rotatable drum in the tub, and one or more distance sensors at an upper position or section of the washing machine (e.g., where the predetermined position in the cabinet is above the tub).

The washing machine may include two or more distance sensors, spaced apart from each other by a preset distance (e.g., in or along a width direction of the washing machine), and the washing machine may further comprise a control unit configured to sense an abnormal installation state (e.g., by determining when a difference between distances sensed by the two distance sensors exceeds a preset range or threshold).

Alternatively, the control unit may be configured to sense when a difference between a current difference value between distances from the two distance sensors and an initial difference value (e.g., corresponding to a difference of distances sensed by the two distance sensors when the two distance sensors initially operate) exceeds a preset range or threshold.

The control unit may alternatively be configured to compare an initial distance from the distance sensor(s) (e.g., when the distance sensor[s] initially operate) and a current distance from the distance sensor(s), and determine whether the current distance differs from the initial distance or exceeds or is smaller than a preset value.

In accordance with yet another aspect of the present invention, there is provided a method of installing a washing machine on a wall, wherein the washing machine comprises a cabinet having an external shape; a rear panel configured to be mounted on the wall; a tub supported by the rear panel and configured to contain wash water; a front panel having an opening over the tub; a rotatable drum in the tub, and one or more distance sensors, comprising installing one or more reflection panels above or below the wall-mounted washing machine, facing the distance sensor(s), spaced apart (e.g., from the distance sensor[s]) by a preset distance. The method may further comprise mounting the washing machine (and specifically the rear panel) on the wall.

The method may further comprise comparing an initial distance from the distance sensor(s) (e.g., when the distance sensor[s] initially operate) and a current distance from the distance sensor(s), and determining whether the current distance is smaller than the initial distance value or exceeds a preset value or threshold.

The washing machine may include two distance sensors spaced apart from each other by a preset distance (e.g., in or along a width direction of the washing machine), and the method may further comprise sensing an abnormal installation state when a difference between distances sensed by the two distance sensors exceeds a preset range or threshold.

The method may alternatively comprise sensing whether a difference between a current difference value between distances from the two distance sensors and an initial difference (e.g., corresponding to a difference of distances from the two distance sensors when the two distance sensors initially operate) exceeds a preset range or threshold.

The present invention may provide a wall-mounted washing machine capable of sensing an abnormal installation state, and a method of installing such a washing machine on a wall.

In addition, the present invention may provide a wall-mounted washing machine capable of sensing the possibility of detaching from the wall and falling in advance, and a method of installing such a washing machine on a wall.

### BRIEF DESCRIPTION OF THE DRAWINGS

FIG. 1 is a perspective view showing the external shape of a wall-mounted washing machine according to an embodiment of the present invention;

FIG. 2 is a view showing an open state of the door in the washing machine of FIG. 1;

FIG. 3 is a perspective view showing the back side of the washing machine of FIG. 1;

FIG. 4 an exploded perspective view showing the washing machine of FIG. 1;

FIG. 5 is a cross-sectional view showing a lower portion of the washing machine taken along the line A-A in FIG. 1;

FIG. 6 is a cross-sectional view showing a lower portion of a wall-mounted washing machine according to another embodiment;

FIG. 7 is a view showing an installed state of a wall-mounted washing machine having a distance sensor as shown in FIG. 5 or 6;

FIG. 8 is a block diagram of a control apparatus and a process for sensing a state of a wall-mounted washing machine;

FIG. 9 is a view showing another installation state of a wall-mounted washing machine; and

FIG. 10 is a view showing an installed state of a wall-mounted washing machine according to another embodiment.

### DETAILED DESCRIPTION

Hereafter, embodiments of the present invention will be described in more detail with reference to the accompanying drawings. The described embodiments of the present invention may be modified in a variety of forms, and the scope of the present invention should not be limited to the embodiments described below. The embodiments are provided to explain the present invention to those skilled in the art. Accordingly, the shapes of the elements in the drawing may be exaggerated to emphasize more clear descriptions.

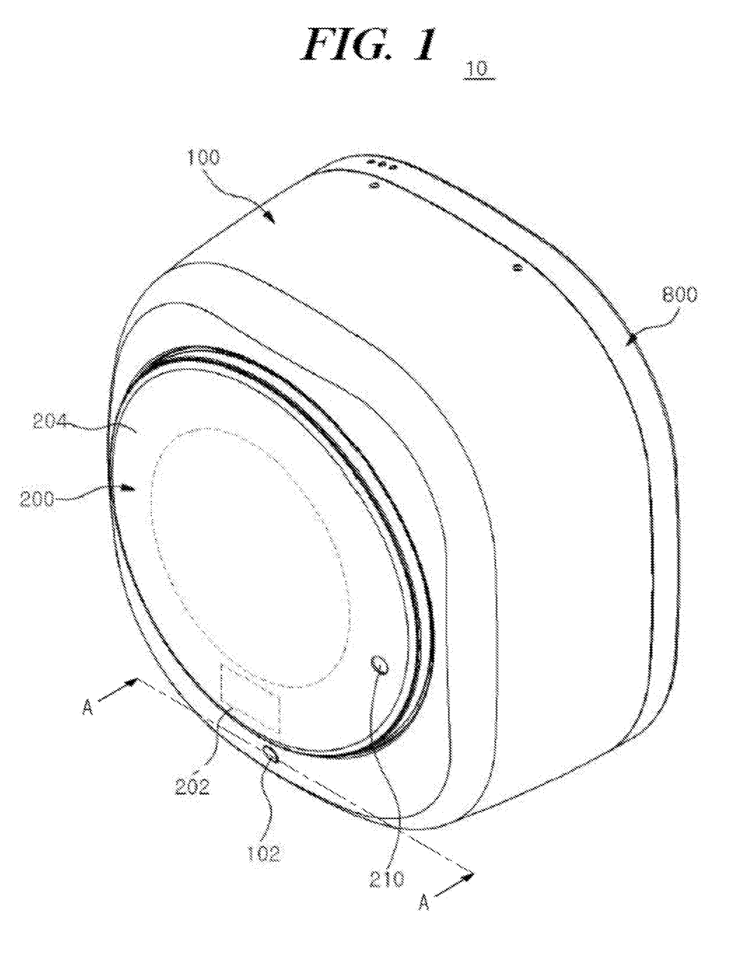

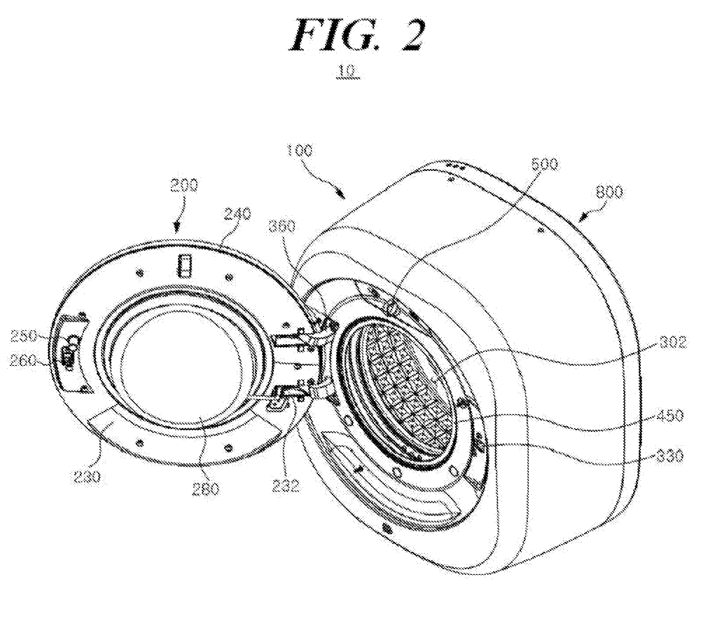

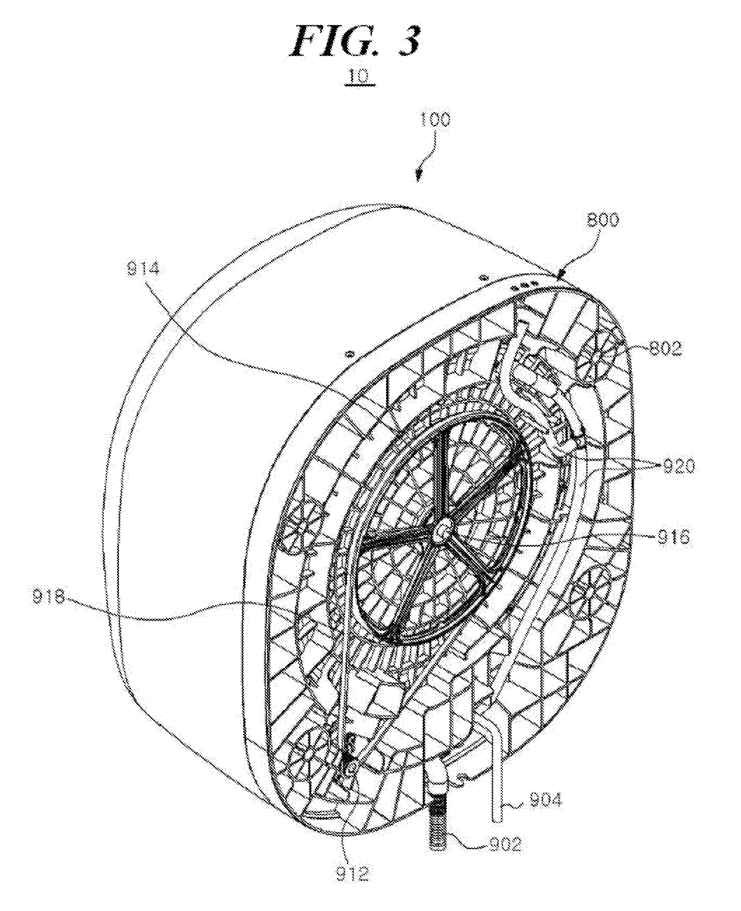

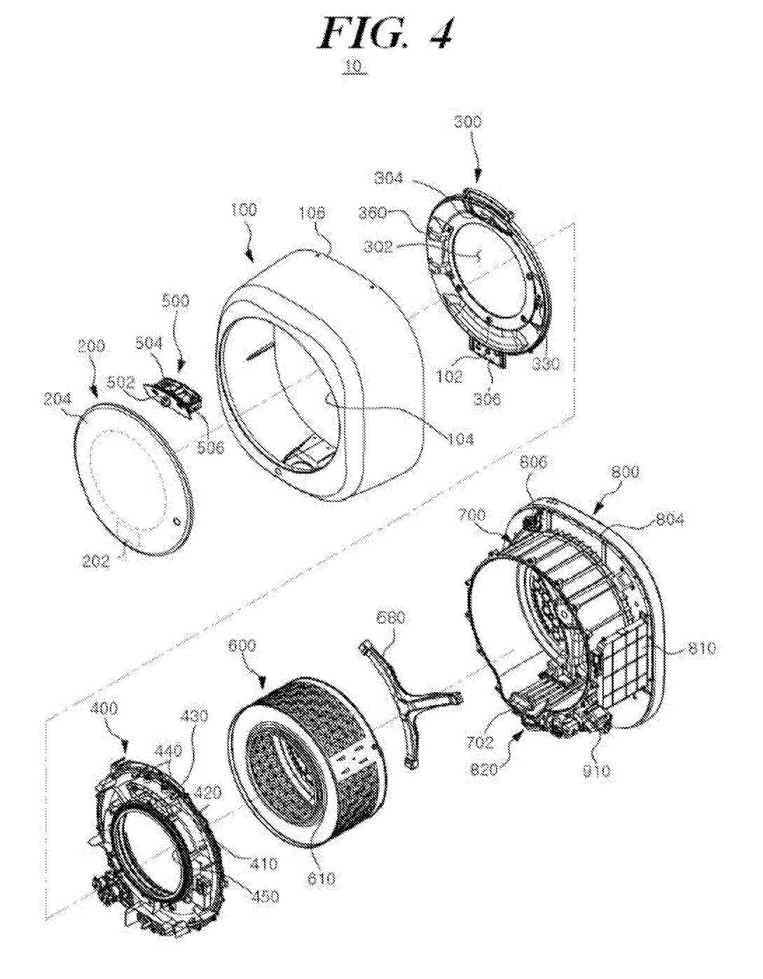

FIG. 1 is a perspective view showing the external shape of a wall-mounted washing machine according to an embodiment of the present invention, FIG. 2 is a view showing an open state of the door in the washing machine of FIG. 1, FIG. 3 is a perspective view showing the back side of the washing machine of FIG. 1, and FIG. 4 is an exploded perspective view of the washing machine of FIG. 1.

Referring to FIGS. 1 to 4, a wall-mounted washing machine 10 according to an embodiment of the present invention may include a cabinet 100 having an external shape, of which the front side and the back side are open, a door 200 at one side of the cabinet 100, configured to open and close an opening in the front side of the cabinet 100, a cover 300 connected to the door 200 (and optionally to the cabinet 100) and containing a latch 330 so that the door 200 may be opened and closed, a front panel 400 behind the cover 300, a detergent box 500 at the front of the front panel, configured to contain detergent and softener, a drum 600 configured to contain laundry, a tub 700 surrounding the drum 600, configured to contain wash water, and a rear panel 800 configured to be mounted on a wall, the “back side” means a side close to the wall, and the “front side” means a side toward the door (opposite to the back side).

Specifically, the cabinet 100 may have an empty interior, and may include a power button 102 on an external surface, configured to control power to the components of the washing machine, a cover connection unit 104 for connecting the cabinet 100 to the cover 300, and a rear panel connection unit 106 for connecting the cabinet 100 to a rear panel 800.

The power button 102 is at one side of the cabinet 100 and may control an on/off function of the washing machine 10. The power button 102 may be on the front of the cabinet 100 so that the user may easily control the on/off function of the washing machine 10. For example, in this embodiment, it is in the front lower side of the cabinet 100. However, the location of the power button 102 is not limited thereto and, for example, it may be on the front left or front right side of the cabinet 100.

The cabinet 100 may include a cover connection unit 104 to connect the cover 300 to the cabinet 100. The cover connection unit 104 may correspond to or be along the edge or periphery of the open front side of the cabinet 100, and may have a diameter smaller than the diameter of the cover 300 so that the cover 300 may not be easily separated from the cabinet 100. Specifically, the cover 300 may be inserted into the cover connection unit 104 from the inner back side of the cabinet 100. Since the diameter of cover connection unit 104 is smaller than the diameter of the cover 300, the cover 300 may be inserted to the cover connection unit 104 (e.g., by stress or pressure), and accordingly, the cover 300 may not be easily separated from the cabinet 100.

The cabinet 100 may include a rear panel connection unit 106 to connect the cover 300 to the rear panel 800. The rear panel connection unit 106 may correspond to or be along the edge or periphery of the open back side of the cabinet 100 and may correspond to the shape of the rear panel 800. The cabinet 300 may be secured or coupled (e.g., by a bolt, screw, or bolt-and-nut combination) to the rear panel 800, and to this end, a plurality of connection holes may be in the rear panel connection unit 106.

Meanwhile, the door 200 may be on the front side of the cabinet 100. When open, the door 200 enables one to put in or take out laundry. The door 200 may include an inner door frame 230 and an outer door frame 240. Specifically, the inner door frame 230 and the outer door frame 240 may be coupled (e.g., by a bolt or bolt-and-nut combination) and may have a predetermined space therebetween. Together, the inner door frame 230 and the outer door frame 240 may be circular and may have a diameter corresponding to the cover connection unit 104. The inner door frame 230 may contact the cover connection unit 104 (e.g., when the door 200 is closed), and the inner door frame 230 and the outer door frame 240 together may completely block the cover 300 (e.g., when the cover 300 is connected to the cabinet 100 and the door 200 is closed).

The inner door frame 230 and the outer door frame 240 may include a door hinge connection unit 232 configured to connect the door 200 to the cover 300. The door hinge connection unit 232 is to one side of the inner door frame 230 and on the same side of the outer door frame 240, and may include a space configured to accommodate a door hinge 360 of the cover 300, which will be described below.

A display 202 may be on an outer surface of the door 200 (e.g., in the inner door frame 230 or in the space between the inner door frame 230 and the outer door frame 240). The display 202 may output or display predetermined information to a user, and the front side thereof may be exposed to the outside of the outer door frame 240. That is, the outer door frame 240 may include a hole (not shown) or may comprise a transparent material so that the display 202 may be exposed and/or visible. The display 202 may be or comprise a touch panel that can receive user inputs and display information outputs, and the user may confirm information such as an operation state or the like using the display 202. The user may also perform operations of the wall-mounted washing machine 10 using the touch display. For example, the user may select a process such as washing, rinsing or the like by touching the display 202 and may confirm a remaining washing time by viewing the display 202.

The outer door frame 240 and the display 202 may be protected by a protection glass or window 204. The protection glass or window 204 is on the front side of the door 200, and since it is transparent, the user may confirm information on or in the display 202. The protection glass or window 204 may have a diameter the same as or similar to (but slightly less than) the inner door frame 230 and/or the outer door frame 240.

A hole or opening (not shown) may be at one side of the protection glass 204, and a door open button 210 may be exposed to the outside through the hole or opening (not shown). The door open button 210 opens the door 200 to expose the inside of the cabinet 100 using an electronic open-and-close method. The door may be closed by simply closing it and allowing the closing mechanism (e.g., an electronic strike) to secure the door in the closed position. The door open button 210 may be in the outer door frame 240 and may be exposed to the outside through the hole (not shown) of the protection glass or window 204.

In addition, the door 200 may include a door open unit 250 and a door latch unit 260. The door open unit 250 and the door latch unit 260 extend toward the back of the door 200 (e.g., the inner door frame 230) and may contact with and be coupled to one side (e.g., the front side) of the cover 300. Specifically, the door open unit 250 performs an open-and-close support function and may have or provide an elastic force. For example, the door open unit 250 may include a spring and may open the door 200 using the elastic force of the spring. For example, when the door 200 is closed, the door open unit 250 may be compressed and be in a hole (not shown) in the front of the cover 300. If the user handles or presses the door open button 210 and the door 200 is opened, the door open unit 250 is separated from the hole (not shown) in the cover 300 and may contact the bottom surface of the hole at one side of the cover 300 while being released. That is, since a space equal to the released length (e.g., of the door open unit 250) is between the door 200 and the cover 300, automatic closing of the door 200 can be prevented.

The door open unit 250 may be supported by the spring and may be inside a guide structure in the inner door frame 230. Alternatively, the door open unit 250 may be or comprise a pusher stem assembly that can repeatedly extend and retract within a predetermined stroke range.

The door latch unit 260 is a predetermined distance from the door open unit 250, and part of the door latch unit 260 may be or comprise a hook extending toward the outside of the inner door frame 230. The extending part of the door latch unit 260 may be coupled to a door locking unit 330 in the cover 300, which will be described below, and accordingly, the door 200 may be closed.

In summary, the door 200 according to an embodiment of the present invention may be opened using the door open button 210. If the user operates (e.g., presses) the door open button 210, the door open unit 250 and the door latch unit 260 may be separated from the cover 300, and accordingly, the door 200 may open and expose the cover 300. The door open unit 250 having elastic force is released, and accordingly, a predetermined space is between the door 200 and the cover, and automatic closing of the door 200 can be prevented.

In addition, the user may close the door 200 by applying pressure to the door 200 toward the cover 300. The user may press one side of the protection glass 204 (e.g., the outermost side of the door 200), and accordingly, the door open unit 250 may be compressed and accommodated in the hole (not shown) in the cover 300, and the extended part of the door latch unit 260 may be coupled to the door locking unit 330 of the cover 300. That is, the door 200 can be opened and closed without a separate handle.

The center portion of the inner door frame 230 and the outer door frame 240 may be open, and a door glass 280 may be in the open center portion. The door glass 280 enables one to see the laundry in the washing machine 10 from the outside and may be inserted into the inner door frame 230 and/or the outer door frame 240. The door glass 280 may protrude or extend toward the back of the washing machine, and the door glass 280 may enter or fit in the opening in the cover 300.

Meanwhile, the door 200 may be hingedly connected to the cover 300 so as to rotate. The cover 300 surrounds the front panel 400 and may include a laundry inlet 302 for putting laundry in the washing machine, a detergent box inlet 304 for inserting the detergent box 500, and a power processing unit 306 responsive to the power button 102.

The user may put laundry in the washing machine 10 through the laundry inlet 302. The laundry inlet 302 may have a predetermined diameter, and the diameter of the laundry inlet 302 may correspond to the size of the protruding part of the door glass 280. Accordingly, if the door 200 is closed, the door glass 280 may block the laundry inlet 302, and if the user opens the door 200, the door glass 280 is separated from the laundry inlet 302 and laundry may be put in through the laundry inlet 302.

The detergent box inlet 304 for inserting the detergent box 500 may be above the laundry inlet 302. The detergent box inlet 304 may correspond to the shape of the detergent box 500.

The cover 300 may include the laundry inlet 302 at the center and may have a circular shape as a whole. The cover 300 may have a region that extends downwards, and the power processing unit 306 may be in this region. The power processing unit 306 controls power according to operation of the power button 102 and may be or comprise a PCB connected (e.g., electrically) to the power button 102.

The cover 300 may include the door locking unit 330 at a position corresponding to the door latch unit 260. The door locking unit 330 may be coupled to the door latch unit 260 and may be or comprise a groove or opening having a shape corresponding to the shape of the door latch unit 260. Accordingly, when the door latch unit 260 is coupled to the door locking unit 330, the door 200 may close the laundry inlet 302.

In addition, the cover 300 may include the door hinge 360 at a position corresponding to the door hinge connection unit 232. The door hinge 360 may be open when one side of the door 200 and one side of the cover 300 are connected, and one side of the door hinge 360 may be accommodated in the door hinge connection unit 232. Specifically, the door hinge 360 may comprise one or more curved panels perpendicular to the laundry inlet 302, the door 200 and/or the cover 300, and part of the door hinge 360 extends toward the front or the washing machine and may be connected to the door hinge connection unit 232 so that the door 200 may rotate. That is, the door 200 may rotate along the part of the door hinge 360 that extends toward the front of the washing machine 10.

Meanwhile, the front panel 400 may be behind the cover 300. The front panel 400 is coupled to the tub 700 and may include a blocking unit 410 configured to block the space between the drum 600 and the tub 700, a detergent box accommodation unit 420 configured to hold or accommodate the detergent box 500, a detergent box gasket 430 configured to tightly seal the detergent box 500 in the detergent box accommodation unit 420, a fitting 440 configured to supply water into the detergent box 500, a door gasket 450 provided to tightly seal the portion of the front panel 400 contacting the door 200, and a water supply valve assembly 480 configured to receive wash water from an external water supply source.

The blocking unit 410 may block the space between the drum 600 and the tub 700 and may have a shape corresponding to the cover 300. That is, the blocking unit 410 may have a diameter the same as or similar to that of the cover 300, and an opening corresponding to the laundry inlet 302 may be at the center (e.g., of the blocking unit 410). Since the opening of the blocking unit 410 is smaller than the diameter of the drum 600, the radial space between the drum 600 and the tub 700 can be blocked, and the user can always place laundry into the drum 600, rather than the tub 700.

The detergent box accommodation unit 420 for the detergent box 500 may be at one side of the blocking unit 410. The detergent box accommodation unit 420 may have a shape corresponding to the detergent box 500 and may communicate (e.g., overlap) with the detergent box inlet 304 in the cover 300. That is, the detergent box 500 may be inserted into the detergent box accommodation unit 420 through the detergent box inlet 304 in the cover 300.

The detergent box accommodation unit 420 may include the detergent box gasket 430, which may be configured to contact the detergent box 500. The detergent box gasket 430 is along the circumference of the opening of the detergent box accommodation unit 420 to tightly seal and/or fix the detergent box 500, and may be or comprise a rubber material. That is, the detergent and the softener in the detergent box 500 and the wash water supplied to the detergent box 500 may not leak to the outside due to the detergent box gasket 430.

One or more fittings 440 may be above the detergent box accommodation unit 420. The fitting 440 is connected to the water supply valve assembly 480 and may supply wash water into the detergent box 500. Accordingly, since the wash water is supplied into the drum 600 and the tub 700 through the detergent box 500, the detergent or the softener may be mixed or dissolved in the wash water supplied to the drum 600 and the tub 700.

Meanwhile, the opening of the blocking unit 410 may include the door gasket 450, which is configured to contact the door glass 280 of the door 200. The door gasket 450 is at a periphery of the opening (e.g., a circular end portion of the opening) and is configured to tightly the seal and fix the door glass 280. The door gasket 450 may comprise a rubber material or the like. Accordingly, when the door 200 is closed, the door glass 280 passing through the laundry inlet 302 of the cover 300 contacts and/or presses against the door gasket 450, and accordingly, the wash water inside the drum 600 and the tub 700 does not leak outside the door 200.

The fitting 440 may be supplied with wash water through the water supply valve assembly 480. The water supply valve assembly 480 is connected to an external water supply source and may selectively supply wash water to the detergent box 50 through the fitting 480. The water supply valve assembly 480 may be or comprise an n-way valve (where n is an integer of at least three). In one embodiment, two passages from the water supply valve assembly 480 are connected to the fitting 440, and one passage from the water supply valve assembly 480 may directly supply wash water to the drum 600 through the door gasket 450.

The detergent box 500 is configured to contain detergent and softener (e.g., in separate compartments), and may include a detergent box handle 502, a detergent compartment 504 configured to hold detergent, and a softener compartment 506 configured to hold fabric softener.

The detergent box handle 502 extends toward the front (e.g., of the washing machine 10) and may be exposed to the outside of the cover 300. Accordingly, after the door 200 is opened, the user may hold the detergent box handle 502 and withdraw or insert the detergent box 500 from or into the detergent box accommodation unit 420. Although it is described in this embodiment as an example that the detergent box handle 502 is at the center on the front of the detergent box 500 and is oriented vertically, the detergent box handle 502 is not limited thereto. For example, the detergent box accommodation unit 420 may be in front of the detergent box 500 and oriented horizontally.

The detergent box 500 is partitioned in the middle inside the detergent box 500 and may include the detergent compartment 504 and the softener compartment 506 that can contain detergent and softener, respectively. The fitting 440 may correspond to the detergent compartment 504 and the softener compartment 506, and detergent and softener in the detergent compartment 504 and the softener compartment 506 may respectively and optionally selectively receive wash water. Specifically, after opening the door 200, the user may withdraw the detergent box 500 from the detergent box accommodation unit 420 and add detergent and softener into the detergent compartment 504 and the softener compartment 506, respectively. The detergent box 500 containing detergent and softener may be inserted into the detergent box accommodation unit 420, and according to a washing or rinsing course or operation, the detergent compartment 504 and the softener compartment 506 may be supplied with wash water, respectively. Accordingly, wash water containing detergent or softener may be selectively supplied to the drum 600 and the tub 700.

The front panel 400 may be connected to the tub 700. The drum 600 contains laundry to be washed and may include a drum entrance or opening 610 in the front and a spider 680 on the back surface. A plurality of holes for fluid communication with the tub 700 may be in the sidewall or periphery of the drum 600.

The drum entrance 610 may correspond to the opened part of the blocking unit 410. The drum entrance 610 may have a diameter smaller than the diameter of the entire drum 600, and the drum entrance 610 overlaps with the opening in the blocking unit 410. Thus, the front panel 400 and the drum 600 may be in communication with each other. Accordingly, the laundry may be put into the drum 600 through the laundry inlet 302 in the cover 300 and the opening in the front panel 400.

The drum 600 may rotate using the spider 680. The spider 680 rotates by receiving a driving (e.g., rotational) force from the driving motor 910, which will be described below. The spider 680 may be separate from the drum 600 and coupled to the back side of the drum 600. A groove or a plurality of slots corresponding to the shape of the spider 680 may be on the back side of the drum 600 so that the spider 680 may rest or reside therein.

The spider 680 may include a plurality of arms extending from the center in different directions at regular intervals. For example, the spider 680 may include arms extending in three or more directions, and each of the arms may have a length corresponding to the radius of the drum 600. The arms may be arranged at intervals of 360°/m, where m is an integer of 3 or more (e.g., 120 degrees). In addition, the center of the spider 680 may be fixed to a second pulley 914, which will be described below, using a drum rotation shaft 916, which will be described below, and thus the spider 680 and the drum 600 coupled to the spider 680 may rotate. The specific rotation method of the drum 600 will be described below.

The tub 700 for containing wash water may be outside the drum 600. The tub 700 may have a shape corresponding to the drum 600 (e.g., cylindrical or substantially cylindrical) and may have a diameter larger than the diameter of the drum 600 (e.g., by a preset amount). Accordingly, the sidewall of the tub 700 may be spaced apart from the outside of the drum 600 by a preset distance. In addition, the wash water inside the tub 700 may flow into the drum 600 through the plurality of holes in the periphery (e.g., sidewall) of the drum 600. In the same manner, the wash water in the drum 600 may flow into the tub 700 through the plurality of holes in the drum 600. Although the drum 600 and the tub 700 may have a cylindrical shape, they are not limited thereto.

In addition, the tub 700 may include a heater 702 configured to heat the wash water. Specifically, a groove or space for placing or resting the heater 702 may be inside the tub 700, and the heater 702 may be detachably inserted in the groove or space inside the tub 700. Accordingly, the heater 702 may heat the wash water in the tub 700.

Meanwhile, the tub 700 may be coupled to or integrated with the rear panel 800 as one body. The rear panel 800 is configured to be mounted on a wall, and may include an anchor connection unit 802 through which an anchor attaches or secures the rear panel 800 to the wall, a cabinet fixing unit 804 configured to fix the cabinet 100 (e.g., to the rear panel 800), and a water level sensor 806 configured to sense the water level in the tub 700.

Specifically, the tub 700 and the rear panel 800 may be injection-molded as one body. The tub 700 is on the front of the rear panel 800, and the back of the rear panel 800 may contact the wall using one or more anchors. The anchor(s) may be secured to the wall through the anchor connection unit 802, and a plurality of anchors may pass through the rear panel 800 for stable mounting. That is, a plurality of anchors may mount the rear panel 800 on the wall. Since the tub 700 and the rear panel 800 are provided as one body, and thus, a separate damper or an elastic member for supporting the tub 700 is not required, the number of parts is reduced, and the size of the washing machine 10 can be reduced.

The cabinet 100 may be coupled to the front side of the rear panel 800, where the tub 700 is provided, to surround the tub 700. The cabinet fixing unit 804 may include one or more steps along the circumference of the rear panel 800, and the cabinet 100 may be fixed to or in contact with the cabinet fixing unit 804. To this end, a connection member such as a bolt, a screw or the like may be used to fix the cabinet 100 to the cabinet fixing unit 804.

In addition, the rear panel 800 may include a control unit 810 configured to control various functions of the wall-mounted washing machine 10, and a drain 820 configured to discharge wash water in the tub 700.

The control unit 810 is on the front of the rear panel 800 and may control various components of the wall-mounted washing machine 10 according to the operation that the user selects. Although it is described in this embodiment as an example that the control unit 810 is on the right side of the tub 700 on the basis of the drawings, the location of the control unit 810 is not limited thereto.

A power line 904 is connected to an external power and may supply power to the electrical equipment described herein, such as the control unit 810, the driving motor 910 and the like. The power line 904 may be in front of the real panel in part, may pass through the rear panel 800, and/or may be on the back side of the real panel 800. The power line 904 may be fixed on the back side of the rear panel 800 using one or more separate connectors. As the power line 904 may extend from the back side of the real panel 800 to the outside or the washing machine 10, the external shape of the washing machine 10 can be finished beautifully.

The drain 820 may be on or near the bottom of the rear panel 800. The drain 820 discharges the wash water in the tub 700 to the outside and may be at the lowest point (and optionally, in the front) of the tub 700. The drain 820 may include a drain pump configured to pump the wash water from the tub 700 and discharge the wash water to a drain hose 902. Specifically, the drain hose 902 is connected (e.g., indirectly) to the drain 820 and exits the washing machine 10 from the back side of the rear panel 800. The wash water may flow to the drain hose 902 by the pressure of the water in and/or over the drain 820. Accordingly, when the drain 820 operates (e.g., after a washing or rinsing course is finished), the wash water may be discharged to the outside of the cabinet 100 through the drain hose 902 by the pressure in and/or on the drain 820.

Meanwhile, the rear panel 800 may include the driving motor 910 configured to provide and/or transfer a driving force (e.g., to an axle or shaft to which a first pulley 912 is affixed), the first pulley 912 connected to the driving motor 910, the second pulley 914, the drum rotation shaft 916 connected to the second pulley 914 to rotate the drum 600, and a belt 918 connecting the first pulley 912 and the second pulley 914.

Specifically, the driving motor 910 may be in front of the rear panel 800. The driving motor 910 may be controlled by the control unit 810 and be at one side of and/or near to the control unit 810 and optionally the drain 820.

In addition, the driving motor 910 may be connected to the first pulley 912. The shaft (not shown) of the driving motor 910 may pass through the rear panel 800, and may be connected to the first pulley 912 behind the rear panel 800.

The first pulley 912 may be connected to the second pulley 914 by the belt 918. The second pulley 914 may surround the drum rotation shaft 916 connected to the spider 680, and the drum rotation shaft 916 may pass through the rear panel 800 while being connected to the spider 680. That is, the second pulley 914 and the drum rotation shaft 916 may be connected behind the rear panel 800.

In summary, if the wash water is fully contained in the tub 700 using the fitting 440, the control unit 810 may operate the driving motor 910. At this point, the first pulley 912 connected to the driving motor 910 rotates, which may then rotate the second pulley 914. Accordingly, since the drum rotation shaft 916 connected to the second pulley 914 also rotates, the drum 600 may rotate inside the cabinet 100 and the tub 700. The laundry in the drum 600 can be thus be washed by rotation of the first pulley 912, the second pulley 914, and the drum rotation shaft 916.

Meanwhile, a discharge line 920 may be further included behind the rear panel 800. The discharge line 920 is connected to the drain 820 and may discharge air in the tub 700 and the drain 820. Specifically, the discharge line 920 may be connected to the drain hose 902, may pass through the rear panel 800 to the back side of the rear panel 800, and may discharge air to the outside or the tub 700.

The wall-mounted washing machine 10 according to one or more embodiments of the present invention as described above may be used as described below.

First, the user may open the door 200 and put laundry into the drum 600 and may withdraw the detergent box 500 from the front panel 400. The detergent box 500 is partitioned in the middle, and spaces for separately putting in detergent and softener may be provided in the detergent box 500.

After inserting the detergent box 500 containing detergent and softener into the front panel 400, the user closes the door 200 and may start a washing operation using the power button 102 and the display 202. When the washing operation begins, wash water supplied from an external water supply source through the water supply valve assembly 480 may be supplied to the detergent box 500 through the fitting 440, and the wash water may be supplied into the drum 600 and the tub 700 after passing through the detergent compartment 504 (or, in the case of a rinsing operation, the softener compartment 506). Thus, the detergent or the softener may be added to the wash water in the drum 600 and the tub 700.

After the wash water is added to the tub 700, the control unit 810 may drive the driving motor 910. The driving motor 910 may be connected to the first pulley 912, which may rotate the second pulley 914, and since the second pulley 914 may be connected to the drum 600 through the drum rotation shaft 916, the drum 600 may rotate using the driving motor 910. By the rotation of the drum 600, the laundry in the drum 600 can be easily washed.

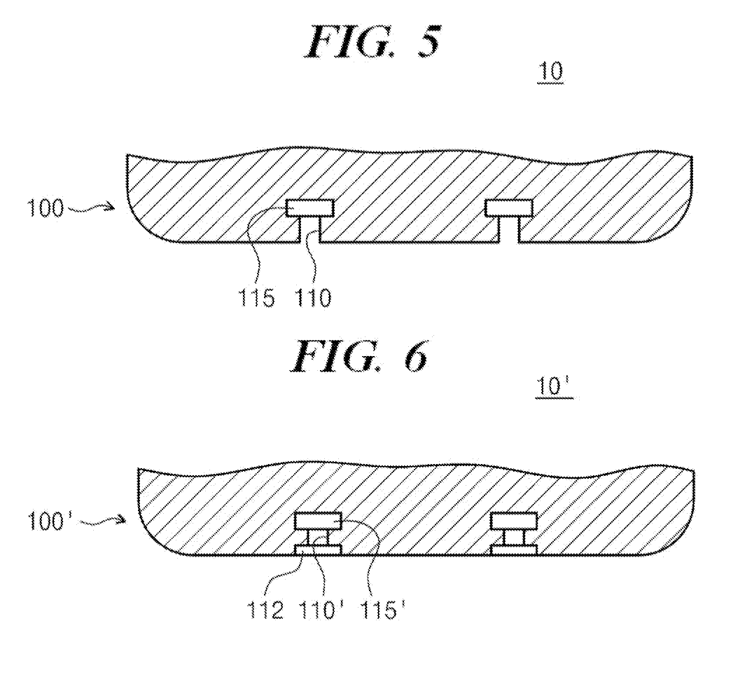

FIG. 5 is a cross-sectional view showing a lower portion (e.g., a lowermost peripheral region) of the washing machine 10 taken along the line A-A in FIG. 1.

Referring to FIG. 5, a distance sensor 115 may be in the wall-mounted washing machine 10. The distance sensor 115 may be in a lower portion of the wall-mounted washing machine 10. The distance sensor 115 may be accommodated inside an accommodation groove, recess or opening 110 in the lower portion (e.g., lowermost surface) of the wall-mounted washing machine 10. The accommodation groove, recess or opening 110 may comprise an opening in the bottom surface of the wall-mounted washing machine 10 and have a preset depth. Accordingly, since the distance sensor 115 is in the accommodation groove, recess or opening 110, one side of the distance sensor 115 may face the outer surface of the wall-mounted washing machine 10 through the opening in the accommodation groove, recess or opening 110. For example, the accommodation groove 110, recess or opening may be in the cabinet 100 that forms the external shape of the wall-mounted washing machine 10.

The washing machine 10 may comprise two or more distance sensors 115. For example, two or more distance sensors 115 may be in the lower portion of the wall-mounted washing machine 10, spaced apart from each other by a preset distance in the width direction of the wall-mounted washing machine 10.

The distance sensor 115 is configured to sense a distance to a facing surface through the opening in the accommodation groove, recess or opening 110. For example, the distance sensor 115 may comprise a laser sensor, an infrared sensor, an ultrasonic sensor or the like that senses the distance using reflections of radiated light, sound waves or the like.

FIG. 6 is a cross-sectional view showing the lower portion (e.g., the lowermost peripheral region) of a wall-mounted washing machine according to another embodiment.

Referring to FIG. 6, a distance sensor 115′ may be in the wall-mounted washing machine 10′. The distance sensor 115′ may be inside an accommodation groove, recess or opening 110′ in the lower portion of the wall-mounted washing machine 10′. The accommodation groove, recess or opening 110′ may face the bottom of the wall-mounted washing machine 10′ and have a preset depth. A window or blocking wall 112 having a transmittance to the radiation emitted by the sensor 115′ (e.g., optical transmittance in the case where the radiation is light) may be on the surface of the cabinet 100′ (e.g., at the bottom of the accommodation groove, recess or opening 110′). Since the configuration and the operation of the distance sensor 115′ are the same as for the distance sensor 115 in FIG. 5 (except that the window 112 is at an end of the accommodation groove, recess or opening 110′), repeated description will be omitted.

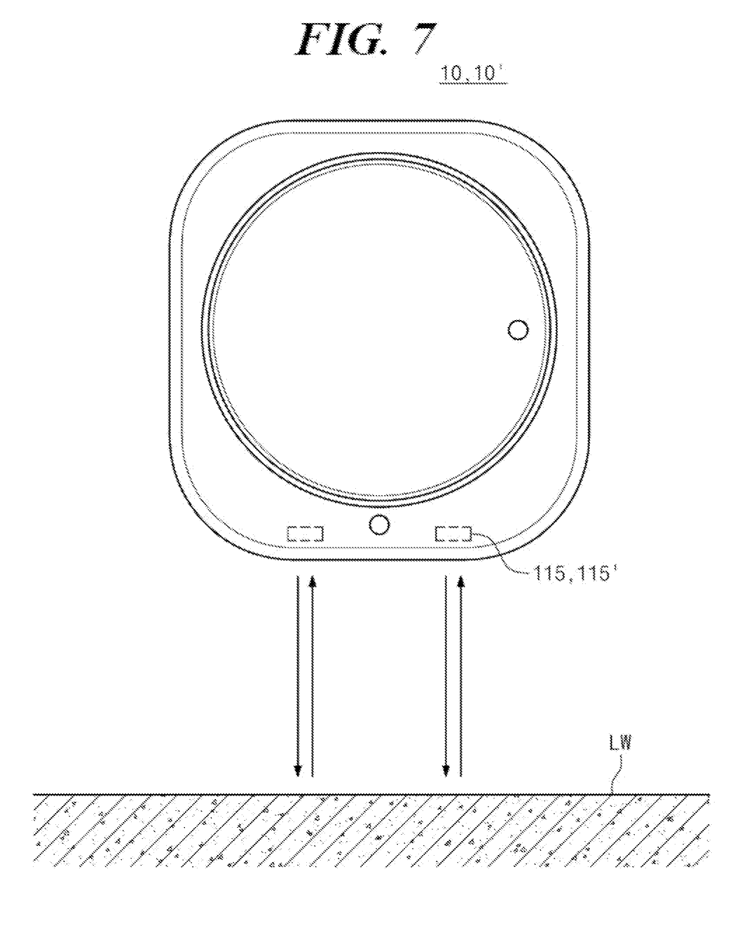

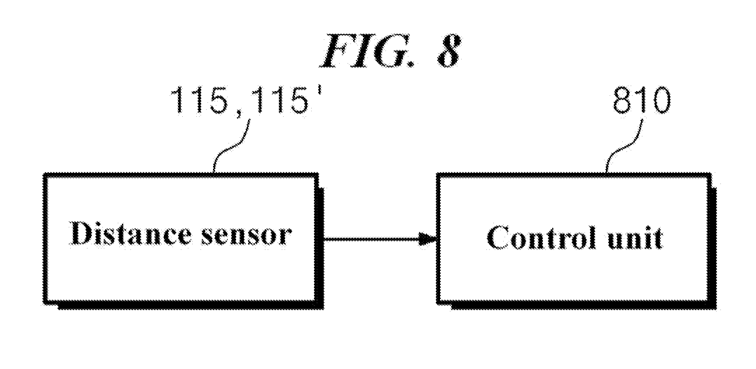

FIG. 7 is a view showing a wall-mounted washing machine having the distance sensor of FIG. 5 or 6 installed on a wall, and FIG. 8 is a block diagram of a control apparatus and a process for sensing a state of a wall-mounted washing machine.

Referring to FIGS. 7 and 8, a wall-mounted washing machine 10, 10′ may sense a state of installation on a wall.

The distance sensor(s) 115, 115′ may sense a distance between the wall-mounted washing machine 10, 10′ and a surface LW below the installation space. For example, the surface LW may be a floor.

The control unit 810 may sense whether the wall-mounted washing machine 10, 10′ is flat (e.g., horizontal, against the wall, etc.) using the distance received from the distance sensor(s) 115, 115′. For example, in the case where the washing machine includes two distance sensors 115, 115′, the distance sensors 115, 115′ may have the same vertical separation distance from the surface LW or a reference point of the washing machine. Accordingly, when the washing machine is installed in a flat state and the state is maintained, the distances sensed by the distance sensors 115, 115′ may be the same. Alternatively, when the distances sensed by the distance sensors 115, 115′ are the same, or a difference between the distances is maintained within a preset range, the control unit 810 may determine that the wall-mounted washing machine 10, 10′ maintains the flat state.

Contrarily, if the difference between the distances sensed by the distance sensors 115, 115′ exceeds the preset range, the control unit 810 may determine that the state of the wall-mounted washing machine 10, 10′ on the wall is abnormal and may generate a notification signal such as a warning sound or the like.

As another example, although the wall-mounted washing machine 10, 10′ is flat when installed, there may be a difference between the distances sensed by the distance sensors 115, 115′. Such a case may occur when the bottom surface LW is not flat. In addition, this may occur when the distance sensors 115, 115′ have different vertical separation distances from the reference point in the washing machine. Accordingly, when the distance sensors 115, 115′ operate initially, the control unit 810 may store an initial difference value corresponding to the difference between the distances provided by the distance sensors 115, 115′. Then, when the difference between the distances sensed by the distance sensors 115, 115′ (e.g., a “current difference”) is the same as the initial difference value or less than a preset deviation (e.g., outside a preset range of difference values), the control unit 810 may determine that the wall-mounted washing machine 10, 10′ remains flat.

Contrarily, if the difference between the distances sensed by the distance sensors 115, 115′ and the initial difference value exceeds the preset range, the control unit 810 may determine that the installation state of the wall-mounted washing machine 10, 10′ is abnormal, and may generate a notification signal such as a warning sound or the like.

In addition, the control unit 810 may sense a stability of the washing machine using the distances sensed by the distance sensor(s) 115, 115′. For example, if the installation state of the wall-mounted washing machine 10, 10′ is unstable, a gap may exist between the back side of the wall-mounted washing machine 10, 10′ and the installation surface, and the wall-mounted washing machine 10, 10′ may pull away from the wall. Accordingly, when the distance sensor(s) 115, 115′ operate initially, the control unit 810 may store the initial distance value(s) from the distance sensor(s) 115, 115′. Then, when the distance value(s) from the distance sensor(s) 115, 115′ become smaller than the initial distance value(s) (or the difference between distance values exceeds a preset value), the control unit 810 may determine that the installation state of the wall-mounted washing machine 10, 10′ is abnormal and that the washing machine is at risk of falling, and thus the control unit 810 may generate an alarm signal.

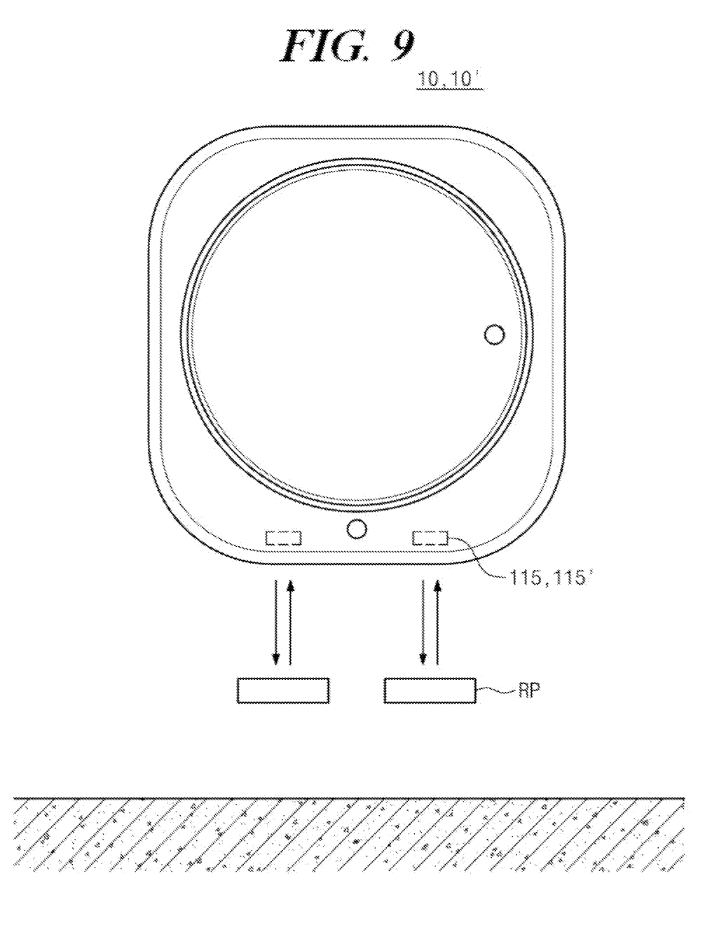

FIG. 9 is a view showing another installation state of a wall-mounted washing machine.

Referring to FIG. 9, reflection panels RP may be below the wall-mounted washing machine 10, and 10′. The reflection panels RP may have one side or surface (e.g., a reflective side or surface) that faces the distance sensor(s) 115, 115′ and is spaced apart from the wall-mounted washing machine 10, 10′ by a preset distance. The reflection panels RP may reflect light or other radiation from the distance sensor(s) 115, 115′.

Accordingly, the distance sensor(s) 115, 115′ may sense a distance between the wall-mounted washing machine 10, 10′ and the reflection panels RP. In addition, the control unit 810 may sense the flatness or falling risk of the wall-mounted washing machine 10, 10′ using the distances sensed by the distance sensor(s) 115, 115′ in a similar way as described with respect to FIGS. 7 and 8. If the reflection panels RP are installed under the wall-mounted washing machine 10, 10′, the distance sensor(s) 115, 115′ may sense a distance from the reflection panels RP regardless of the topography of the space below the wall-mounted washing machine 10, 10′.

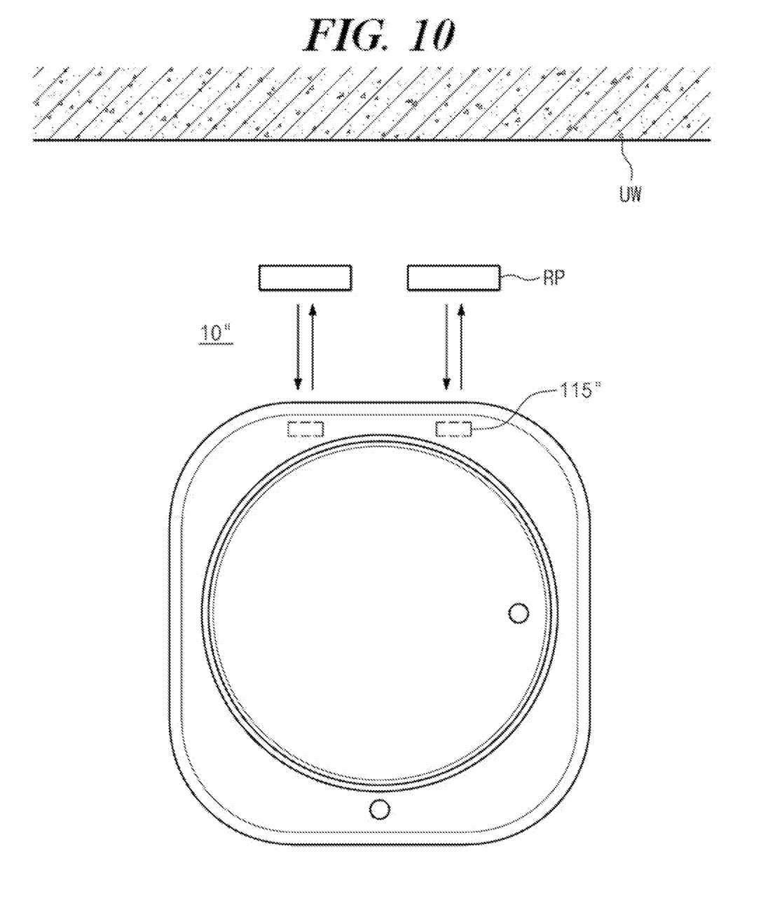

FIG. 10 is a view showing a wall-mounted washing machine installed on a wall according to another embodiment.

Referring to FIG. 10, the distance sensor(s) 115″ may be in an upper section or portion (e.g., above the tub 700, but below the uppermost surface of the cabinet 100) in the wall-mounted washing machine 10″. Accordingly, the distance sensor(s) 115″ may sense a distance between a top or upper surface UW and the wall-mounted washing machine 10″. For example, the top or upper surface UW may be a ceiling or an overhanging shelf. Since the structure of the distance sensor(s) 115″ in the wall-mounted washing machine 10″ and the functions are the same as, the inverse of, or similar to those shown in FIG. 5 and FIG. 6, except that the distance sensor(s) 115″ are located in an upper section or portion of the wall-mounted washing machine 10″, repeated description will be omitted.

In addition, the control unit 810 may sense the installation state of the wall-mounted washing machine 10″ through the distance values provided by the distance sensor(s) 115″ in a similar way to that described with reference to FIGS. 7 and 8.

In addition, one or more reflection panels RP may be above the wall-mounted washing machine 10″. Thus, the distance sensor(s) 115″ may sense the distances between the reflection panel(s) RP and the distance sensor(s) 115″ in the wall-mounted washing machine 10″, and the control unit 810 may sense the installation state of the wall-mounted washing machine 10″ using the sensed distances.

The present invention may provide a wall-mounted washing machine capable of sensing an installation state (e.g., of the washing machine) and a method of installing the washing machine.

In addition, the present invention may provide a wall-mounted washing machine capable of sensing possibility of falling in advance and a method of installing the washing machine.

The above detailed description provides examples of the present invention. In addition, the above description explains by showing preferred embodiments of the present invention, and the present invention may be used in various different combinations, changes and environments. That is, the present invention may be modified or changed within the scope of the spirit of the present invention disclosed in this specification, within a scope equivalent to the disclosed contents, and/or within the scope of the technique(s) or knowledge of the prior art. The above embodiments describe the best conditions for implementing the technical spirit of the present invention, and various changes in the specific application fields and usages of the present invention also can be made. Accordingly, the detailed description of the present invention as described above shows disclosed embodiments and is not intended to limit the present invention. In addition, the appended claims should be interpreted as also including other embodiments.

What is claimed is:

1. A washing machine, comprising:
a cabinet having an external shape;
a rear panel configured to be mounted on a wall;
a tub supported by the rear panel and configured to contain wash water;
a front panel having an opening over the tub;
a rotatable drum in the tub, and
a distance sensor.

2. The washing machine according to claim 1, further comprising an accommodation groove in a surface of the cabinet and having a preset height, length or depth, and the distance sensor is in the accommodation groove.

3. The washing machine according to claim 2, wherein the accommodation groove is in a lower portion or section of the wall-mounted washing machine.

4. The washing machine according to claim 2, further comprising a window having a transmittance in the accommodation groove.

5. The washing machine according to claim 4, wherein the transmittance is an optical transmittance.

6. The washing machine according to claim 2, comprising two distance sensors spaced apart from each other by a preset distance.

7. The washing machine according to claim 6, wherein the two distance sensors are spaced apart from each other in or along a width direction of the washing machine.

8. The washing machine according to claim 6, further comprising a control unit configured to sense an abnormal installation state when a difference between distances sensed by the two distance sensors exceeds a preset range or threshold.

9. The washing machine according to claim 6, further comprising a control unit configured to sense when a difference between a current difference between distances from the two distance sensors and an initial difference value exceeds a preset range or threshold.

10. The washing machine according to claim 1, further comprising a control unit configured to compare an initial distance from the distance sensor and a current distance from the distance sensor, and determine whether the current distance value differs from the initial distance value.

11. The washing machine according to claim 1, wherein the control unit is configured to sense when the current distance value exceeds a preset value.

12. The washing machine according to claim 1, wherein the distance sensor is at an upper position or section of the washing machine.

13. The washing machine according to claim 12, comprising two distance sensors spaced apart from each other by a preset distance, and the washing machine further comprises a control unit configured to sense an abnormal installation state when a difference between distances sensed by the two distance sensors exceeds a preset range or threshold.

14. The washing machine according to claim 12, comprising two distance sensors spaced apart from each other by a preset distance, and the washing machine further comprises a control unit configured to sense when a difference between a current difference value between distances from the two distance sensors and an initial difference value exceeds a preset range or threshold.

15. The washing machine according to claim 12, further comprising a control unit configured to compare an initial distance from the distance sensor and a current distance from the distance sensor, and determine whether the current distance value differs from the initial distance value or exceeds a preset value.

16. A method of installing a washing machine on a wall, wherein:
the wall-mounted washing machine comprises:
a cabinet having an external shape;
a rear panel configured to be mounted on the wall;
a tub supported by the rear panel and configured to contain wash water;
a front panel having an opening over the tub;
a rotatable drum in the tub;
a distance sensor; and
a reflection panel; and
the method comprises installing the reflection panel above or below the wall-mounted washing machine by a preset distance, such that the reflection panel faces the distance sensor.

17. The method according to claim 16, wherein the washing machine is configured to compare an initial distance value from the distance sensor and a current distance value from the distance sensor, and sense when the current distance value differs from the initial distance value or exceeds a preset value.

18. The method according to claim 16, wherein the washing machine comprises two distance sensors spaced apart from each other by a preset distance, and the wall-mounted washing machine is configured to sense an abnormal installation state when a difference between distances sensed by the two distance sensors exceeds a preset range or threshold.

19. The method according to claim 16, wherein the washing machine comprises two distance sensors spaced apart from each other by a preset distance, and the wall-mounted washing machine is configured to sense when a difference between a current difference value from the two distance sensors and an initial difference value exceeds a preset range or threshold.
